(19) United States
(12) Patent Application Publication
(10) Pub. No.: US 2006/0027048 A1
(43) Pub. Date: Feb. 9, 2006

(54) SELECTIVE ONE-WAY PNEUMATIC TOOL

(76) Inventor: Ting-Yuan Chen, Taya Hsiang (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/163,490

(22) Filed: Oct. 20, 2005

Related U.S. Application Data
(63) Continuation-in-part of application No. 10/683,290, filed on Oct. 14, 2003.

(51) Int. Cl. B25B 13/46

(52) U.S. Cl. 81/57.39

(57) ABSTRACT

A selective one-way pneumatic tool includes a handle and a head connected to the handle. The head includes two plates and a wall between the plates for enhancing the strength and cushioning effects. An annular gear can rock between the plates. A selective one-way driver can transform the rocking of the annular gear to selective one-way rotation. A pneumatic motor is put in the handle in order to transform the flow of pressurized air into rotation. A transmission is put in the handle in order to transform the rotation of the pneumatic motor to the rocking of the annular gear.

### CROSS-REFERENCE

The present application is a continuation-in-part application of co-pending U.S. patent application Ser. No. 10/683,290 of which the entire disclosure will be incorporated herein.

### BACKGROUND OF INVENTION

1. Field of Invention

The present invention relates to a selective one-way pneumatic tool.

2. Related Prior Art

Referring to FIGS. 1 and 2, there is shown a conventional pneumatic tool with a handle 1 and a head 2. The head 2 includes two separate frames 4 between which a space 3 is defined. In the head 2, along the axis of the handle 1 extends an opening 5 in communication with the space 3. A cam 6 and a collar 7 are put in the space 2 through the opening 5. An annular gear 8 is put in the space 3. A gear 9 is put in the annular gear 8. A selective one-way transmission (not shown) is provided between the annular gear 8 and the gear 9. In action, the cam 6 rotates the collar 7 that in turn rocks the annular gear 8. Through the selective one-way transmission, the annular gear 8 rotates the gear 9 in selective one of two opposite directions. However, its operation is not reliable and its lifecycle is short. The annular gear 8 causes impact against the frames 4. The frames 4 are separate cantilevers that show poor strength and cushioning effects. Therefore, the engagement of the annular gear 8 with the gear 9 through the selective one-way transmission tends to slack off and they tend to wear away one another.

The present invention is therefore intended to obviate or at least alleviate the problems encountered in prior art.

### SUMMARY OF INVENTION

According to the present invention, a selective one-way pneumatic tool includes a handle and a head connected to the handle. The head includes two plates and a wall between the plates for enhancing the strength and cushioning effects. An annular gear can rock between the plates. A selective one-way driver can transform the rocking of the annular gear to selective one-way rotation. A pneumatic motor is put in the handle in order to transform the flow of pressurized air into rotation. A transmission is put in the handle in order to transform the rotation of the pneumatic motor to the rocking of the annular gear.

An advantage of the pneumatic tool is the enhanced strength of the head for the use of the wall.

Another advantage of the pneumatic tool is the improved cushioning effects of the head for the use of the wall.

Other advantages and features of the present invention will become more apparent from the detailed description referring to the drawings.

### BRIEF DESCRIPTION OF DRAWINGS

The present invention will be described through illustration of the preferred embodiment in contrast to an example of prior art referring to the drawings.

FIG. 1 is a perspective view of a conventional selective one-way pneumatic tool.

FIG. 2 is an exploded view of the conventional selective one-way pneumatic tool shown in FIG. 1.

FIG. 3 is a perspective view of a selective one-way pneumatic tool according to the preferred embodiment of the present invention.

FIG. 4 is an exploded view of the selective one-way pneumatic tool shown in FIG. 3.

FIG. 5 is a cross-sectional view taken along a line 5-5 in FIG. 3.

FIG. 6 is a cross-sectional view taken along a line 6-6 in FIG. 5.

FIG. 7 is a cross-sectional view taken along a line 7-7 in FIG. 5.

FIG. 8 shows the selective one-way pneumatic tool in a different position from that is shown in FIG. 5.

FIG. 9 is another cross-sectional view of the selective one-way pneumatic tool shown in FIG. 8.

FIG. 10 is a cross-sectional view taken along a line 10-10 in FIG. 6.

FIG. 11 shows the selective one-way pneumatic tool in a different position from that is shown in FIG. 10.

FIG. 12 shows the selective one-way pneumatic tool in a different position from that is shown in FIG. 11.

FIG. 13 shows the selective one-way pneumatic tool in a different position from that is shown in FIG. 12.

FIG. 14 shows the selective one-way pneumatic tool in a different position from that is shown in FIG. 13.

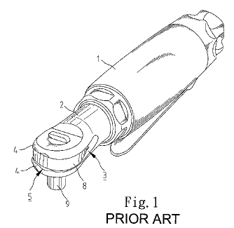

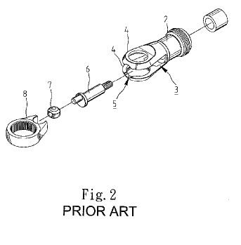

### DETAILED DESCRIPTION OF PREFERRED EMBODIMENT

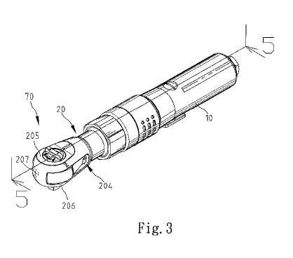

Referring to FIG. 3, there is shown a selective one-way pneumatic tool according to the preferred embodiment of the present invention. The tool includes a handle 10 and a head 20.

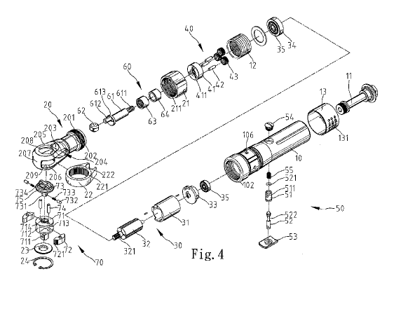

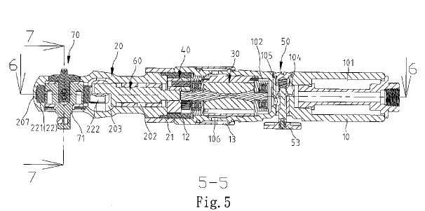

Referring to FIGS. 4 and 5, the handle 10 is a cylinder with a first end and a second end. The handle 10 defines a first axial space 101 near the first end, a second axial space 102 near the second end and a transverse space 103 between the axial spaces 101 and 102. Via a channel 104, the first axial space 101 is in communication with the transverse space 103. Through a channel 105, the second axial space 102 is in communication with the transverse space 103. The handle 10 further defines a plurality of vents 106 in communication with the second axial space 102.

The first axial space 101 can receive a joint 11 connected to a pipe (not shown) connected to an air compressor (not shown). Pressurized air can be provided to the handle from the air compressor. The second axial space 102 receives a pneumatic motor 30 for transforming the flow of the pressurized air into rotation. After driving the pneumatic motor 30, the pressurized air leaves the second axial space 102 through the vents 106. The vents 106 are shielded by means of a diffuser 13 defining apertures 131. While going through the apertures 131, the pressured air is diffused so that its pressure and speed are reduced.

The pneumatic motor 30 includes a housing 31 put in the second axial space 102, a rotor 32 put in the housing 31, a rear cover 33 for closing a rear open end of the housing 31 and a front cover 34 for closing a front open end of the housing 31. Each of the covers 33 and 34 is equipped with a bearing 35 in order to bear the rotor 32. The rotor 32 includes an axle 321 extended from an end.

A first transmission 40 is put in the second axial space 102 and connected to the pneumatic motor 30. The first transmission 40 includes an annular gear 12 fit in the second axial space 102, three planet gears 43 provided between the annular gear 12 and the axle 321, three pins 42 on which the planet gears 43 are installed and a ring 41 to which the pins 42 are connected. The planet gears 43 are engaged with the annular gear 12. On the other hand, the planet gears 43 are engaged with the axle 321. The rotation of the axle 321 can be transmitted to the ring 41 through the planet gears 43 at a reduced speed. The ring 41 is in fact an annular gear with a plurality of teeth 411 formed on the interior.

In the transverse space 103 is installed a valve 50 for controlling the communication of fluid between the axial spaces 101 and 102. The valve 50 includes a housing 51 fit in the transverse space 103, a core 52 put in the housing 51, a button 53 connected to the core 52, a cover 54 for closing the transverse space 103 and a spring 55 compressed between the cover 54 and the core 52.

The housing 51 includes two open ends (not numbered) one of which is in communication with the channel 104 and a peripheral aperture 511 in communication with the channel 105.

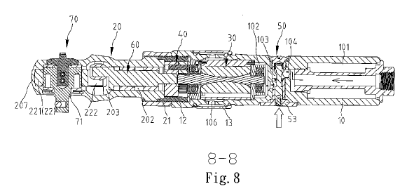

The core 52 includes a reduced portion 522. An annular seal 521 is put around the core 52 next to the reduced portion 522. The core 52 is movable between two positions. In the first position, referring to FIG. 5, the annular seal 521 seals the open end of the housing 51 so that the axial spaces 101 and 102 are shut from each other. In the second position, referring to FIG. 8, the reduced portion 522 releases the open end of the housing 51 so that the axial spaces 101 and 102 are in communication with each other. The core 52 will be moved to the second position when the button 53 is pushed. The spring 55 will push the core 52 back to the first position when the button 53 is released.

The head 20 includes a first end and a second end opposite to the first end. The first end of the head 20 is connected to the second end of the handle 10 by means of a nut 21. To this end, the head 20 includes a thread 201 for engagement with a thread 211 of the nut 21.

The head 20 defines a tunnel 202 near the first end, a space 204 near the second end and a recess 203 for communicating the tunnel 202 with the recess 203. The space 204 separates the second end of the head 20 to an upper plate 205 and a lower plate 206. Between the plates 205 and 206 is formed a wall 207 for enhancing the strength and the cushioning effects of the head 20. The wall 207 is located at an end of the head 20 so that the space 204 opens on two opposite sides of the head 20. The upper plate 205 defines an opening 208. The lower plate 206 defines an opening 209. The diameter of the opening 209 is marginally larger than that of the opening 208.

A second transmission 60 includes an axle 61, a collar 62, a bearing 63 and an annular plug 64. The axle 61 is mainly put in the tunnel 202. The axle 61 includes a first end inserted to the ring 41 and a second end put in the recess 203. On the first end of the axle 61 is formed a plurality of teeth 611 engaged with the teeth 411 of the ring 41. On the second end of the axle 61 is formed a cam. The cam consists of a wheel 613 and a rocker 612 eccentrically formed on the wheel 613. The collar 62 is installed on the rocker 612.

An annular gear 22 is substantially put in the space 204. The annular gear 22 includes a yoke 222 on the exterior for engagement with the collar 62 and a plurality of teeth 221 on the interior.

There is provided a selective-one way driver 70 consisting of a body 71, two pawls 72 and a switch 73.

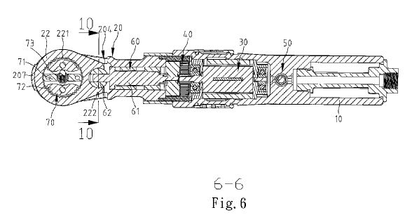

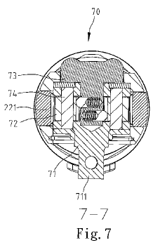

Referring to FIGS. 6 and 7, the body 71 is mainly put in the annular gear 22 in the space 204. The body 71 includes a non-circular insert 711 for insertion in a corresponding recess in a socket (not shown) for driving a bolt or nut. The body 71 further includes two partitions 712 opposite to the non-circular insert 711, two rooms 713 on two opposite sides of the partitions 712 and a pocket 714 between the partitions 712, thus communicating the rooms 713 with each other.

Each of the pawls 72 is put in related one of the rooms 713 so that the pawls 72 are separated from each other by means of the partition 712. Each of the pawls 72 is pivotally connected to the body 71 by means of a pin 74. Each of the pawls 72 includes two ends (not numbered) each formed with a plurality of teeth 721 for engagement with the teeth 221.

The switch 73 includes a column 731 put in the pocket 714, two springs 733 put in two holes (not numbered) in the column 731, two detents 732 put against the springs 733 and a knob 734 on the column 731. A washer 75 is provided between the knob 734 and the body 71. The detents 732 contact the pawls 72.

There are provided a ring 23 and a C-clip 24 in the opening 29 in order to prevent the selective one-way driver 70 from falling from the space 204 through the opening 29.

Referring to FIG. 6, the teeth 721 of the pawls 72 are disengaged from the teeth 221 of the annular gear 22. Hence, the body 71 will remain still when the pneumatic tool is turned on as the button 53 is pushed referring to FIG. 8.

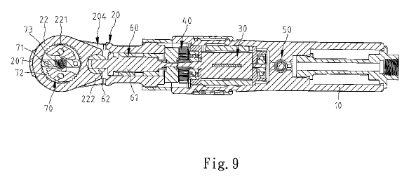

Referring to FIGS. 9 and 10, when the knob 734 is turned, the body 71 and hence the detents 732 will be turned. The detents 732 pivot the pawls 72. The teeth 721 at one of the ends of each of the pawls 72 are engaged with the teeth 221 of the annular gear 22.

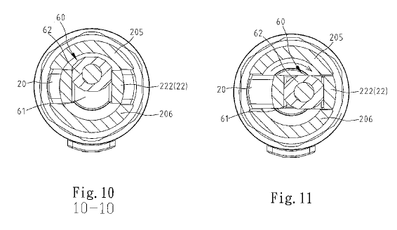

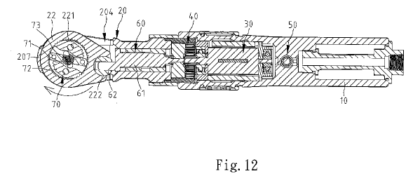

While moving to the position shown in FIG. 11, the collar 62 drives the annular gear 22 to the position shown in FIG. 12, i.e., clockwise. The annular gear 22 in turn drives the pawls 72 and the body 71.

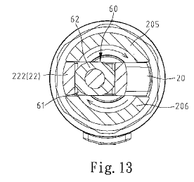

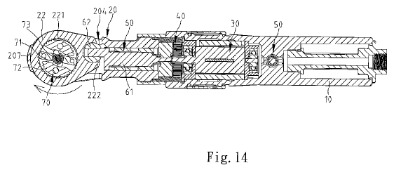

While moving to the position shown in FIG. 13, the collar 62 drives the annular gear 22 to the position shown in FIG. 14, i.e., counterclockwise. The annular gear 22 cannot drive the pawls 72 and the body 71 since the detents 732 and the springs 733 allow the pawls 72 to escape from the annular gear 22.

An advantage of the selective one-way pneumatic tool is the enhanced strength of the head 20 for the use of the wall 207. Another advantage of the selective one-way pneumatic tool is the improved cushioning effects of the head 20 for the use of the wall 207. Still another advantage of the selective one-way pneumatic tool is its reliability for the use of two pawls 72. Still another advantage of the selective one-way pneumatic tool is its extended lifecycle for the use of two pawls 72.

The present invention has been described through the illustration of the preferred embodiment. Those skilled in the art can derive variations from the preferred embodiment without departing from the scope of the present invention. Therefore, the preferred embodiment shall not limit the scope of the present invention defined in the claims.

What is claimed is:

1. A selective one-way pneumatic tool comprising:
a head comprising two plates and a wall formed between the plates for enhancing the strength and cushioning effects;
an annular gear for rocking between the plates;
a selective one-way driver for transforming the rocking of the annular gear to rotation in selective one of two directions a handle connected to the head;
a pneumatic motor put in the handle in order to transform the flow of pressurized air into rotation; and
a transmission put in the handle in order to transform the rotation of the pneumatic motor to the rocking of the annular gear.

2. The selective one-way pneumatic tool according to claim 1 wherein the selective one-way driver comprises:
a body put in the annular gear;
two pawls put on the body between first and second active positions engaged with the annular gear through a neutral position disengaged from the annular gear, wherein the annular gear can only rotate the pawls in a first direction in the first active position, wherein the annular gear can only rotate the pawls in a second direction in the second active position; and
a switch rotationally installed on the body in order to switch the pawls between the first and second active positions.

3. The selective one-way pneumatic tool according to claim 2 wherein the body comprises two partitions for separating one of the pawls from the other pawl, wherein the switch is put between the partitions.

4. The selective one-way pneumatic tool according to claim 2 wherein the body comprises a non-circular insert for fitting in a corresponding hole in a socket.

5. The selective one-way pneumatic tool according to claim 2 wherein the selective one-way driver comprises two pins for pivotally connecting the pawls to the body.

6. The selective one-way pneumatic tool according to claim 2 wherein each of the pawls comprises two ends for engagement with the interior of the annular gear.

7. The selective one-way pneumatic tool according to claim 2 wherein the switch comprises a column put rotationally between the partitions and two spring-biased detents each compressed between one of the pawls and the column.

8. The selective one-way pneumatic tool according to claim 7 wherein the switch comprises a knob on the column.

9. The selective one-way pneumatic tool according to claim 8 wherein the selective one-way driver comprises a washer put between the knob and the body.

10. The selective one-way pneumatic tool according to claim 1 further comprising an auxiliary transmission between the pneumatic motor and the transmission.
